(19) United States
(12) Patent Application Publication
(10) Pub. No.: US 2009/0041390 A1
(43) Pub. Date: Feb. 12, 2009

(54) Data file outputting program product and data file outputting device

(75) Inventors: Hiromi Kuwata, Chiba-shi (JP); Nobuhiro Hayashi, Tokyo (JP); Mayumi Nakayama, Chofu-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/222,172

(22) Filed: Aug. 4, 2008

(30) Foreign Application Priority Data
Aug. 6, 2007 (JP) 2007-204455

(51) Int. Cl. G06K 9/03

(52) U.S. Cl. 382/311

(57) ABSTRACT

A computer-readable computer program product that contains a data file outputting program for causing a computer to execute: a read-in instruction for reading in a plurality of data groups from a storage medium having recorded therein in correlation to each other post-edition data, pre-edition data and edition history data, and each of the plurality of data groups including the post-edition data, the pre-edition data, and the edition history data in correlation to each other, one group after another; a data creation instruction for applying, for each of the plurality of data groups, a content of edition at each point in time of edition to the pre-edition data based on the edition history data to create edition process data at each point in time; and a file output instruction for outputting in batch the post-edition data, the pre-edition data, and the edition process data as different data files, respectively.

### INCORPORATION BY REFERENCE

The disclosure of the following priority application is herein incorporated by reference:

Japanese Patent Application No. 2007-204455 filed Aug. 6, 2006.

### BACKGROUND OF THE INVENTION

1. Field of the Invention

The present invention relates to a data file outputting program product and a data file outputting device for outputting data files.

2. Description of Related Art

Japanese Patent Laid-Open Application No. 2006-350634 discloses an image processing device that stores a history of image processing on an image and when any point in time in the history is designated by a user, performs the image processing at the designated point in time on the image.

### SUMMARY OF THE INVENTION

However, in the conventional image processing device, it is necessary for the user to specifically designate the point in time of the processing that is desired to be performed on the image. Accordingly, when it is desired to output all the images prepared in the course of the image processing in the past, complicated operations are required.

In a first aspect, the present invention provides a computer-readable computer program product that contains a data file outputting program causing a computer to execute: a read-in instruction for reading in a plurality of data groups from a storage medium, the storage medium having recorded therein in correlation to each other a plurality of post-edition data as a result of edition by a user, a plurality of pre-edition data, which are originals of the post-edition data, and a plurality of edition history data in which contents of editions applied to the pre-edition data have been recorded at each point in time of edition in the course of creating the post-edition data, and each of the plurality of data groups including the post-edition data, the pre-edition data, and the edition history data in correlation to each other, one group after another; a data creation instruction for applying, for each of the plurality of data groups read in by the read-in instruction, the content of edition at each point in time of edition to the pre-edition data based on the edition history data to create edition process data at each point in time; and a file output instruction for outputting in batch the plurality of post-edition data, the plurality of pre-edition data, and the plurality of edition process data created by the data creation instruction as different data files, respectively.

In a second aspect, the computer-readable computer program product according to the first aspect is preferably configured such that in the file outputting instruction, file names each containing the same character string to a data file of the post-edition data, a data file of the pre-edition data, anda data file of the edition process data, respectively, are assigned to the post-edition data, the pre-edition data, and the edition process data being correlated to each other.

In a third aspect, the computer-readable computer program product according to the first aspect is preferably configured such that the post-edition data, the pre-edition data, and the edition process data are stored in a database to be correlated to each other.

In a fourth aspect, the computer-readable computer program product according to the first aspect is preferably configured such that the post-edition data, the pre-edition data, and the edition process data are stored in a data file to be correlated to each other.

In a fifth aspect, the computer-readable computer program product according to the first aspect is preferably configured such that the pre-edition data and the post-edition data are image data, respectively, and the edition history data are data having recorded therein parameters representing a content of image processing performed on the pre-edition data.

In a sixth aspect, the present invention provides a data file outputting device includes a program executing unit that executes a data file outputting program that is contained in the computer-readable computer program product according to the first aspect.

### BRIEF DESCRIPTION OF THE DRAWINGS

FIG. 1 is a block diagram showing a configuration of a data file outputting device according to an embodiment of the present invention;

FIG. 2 is a flowchart illustrating processing by the data file outputting device according to an embodiment of the present invention; and

FIG. 3 is a schematic diagram showing an overall configuration of equipment used for providing a program product.

### DESCRIPTION OF PREFERRED EMBODIMENTS

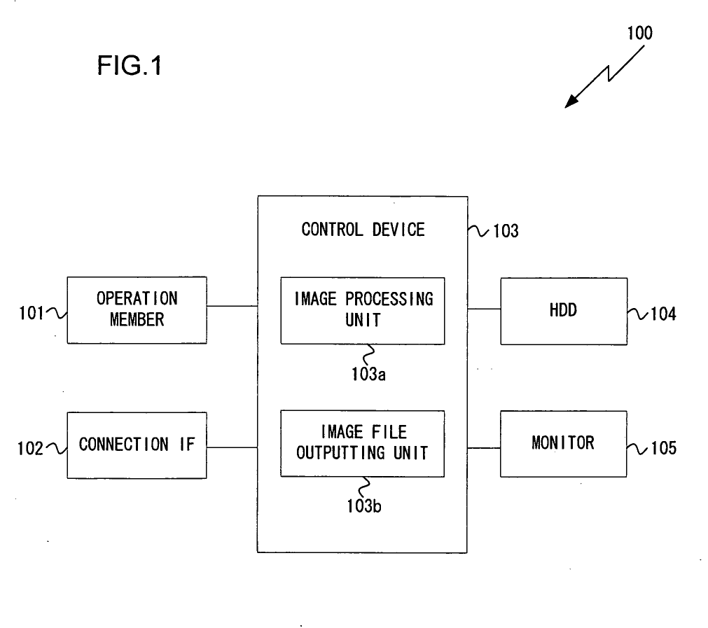

FIG. 1 is a block diagram showing a configuration of a data file outputting device according to an embodiment of the present invention. A data file outputting device 100, for example, a personal computer, includes an operation member 101, a connection IF (Interface) 102, a control device 103, a HDD (Hard Disk Drive) 104, and a monitor 105.

The operation member 101 includes various devices to be operated by a user, for example, a keyboard and a mouse. The connection IF 102 is an interface to connect with an external device such as a digital camera. For example, a USB interface for wireline connection with a digital camera, a wireless LAN module for wireless connection, and so on. In the present embodiment, image files are downloaded from a digital camera to the data outputting device though, for example, the connection IF 102.

The HDD 104 is a storage medium that records image files downloaded from a digital camera through the connection IF 102 and various programs to be executed by the control device 103. The monitor 105 is, for example, a liquid crystal monitor, which displays various pieces of information output from the control device 103.

In the present embodiment, the image file downloaded through the connection IF 102 and recorded in the HDD 104 is an image file of a predetermined format, for example, Exif (Exchangeable Image File Format for Digital Still Camera) or the like. The image file of the Exif format includes image data compressed into a predetermined image format, for example, Jpeg format as a main image and an additional information section that contains a thumbnail image created by reducing the main image and time and date in which the image was taken.

In the present embodiment, the additional information section of the image file contains edition history data that represent a history of image processing on the main image performed in the past. As the edition history data, there are recorded, for example, a set of image processing parameters representing the content of the image processing performed on the main image in the past for each point in time of editing.

That is, the user can use various image processing applications installed in the data file outputting device 100 to perform image processing on the main image contained in the image file recorded in the HDD 104. Also, there is a possibility that before downloaded by the data file outputting device 100, the main image has already been subjected to image processing by another device. When it is instructed by the user to execute image processing, each image processing application accepts an instruction by the user to record an image processing history. When it is instructed to record the image processing history, each image processing application records the set of the image processing parameters as the edition history data in the addition information section. The set of the image processing parameters represents the content of the image processing performed to the main image when it is instructed to record the image processing history.

Further, in the additional information section, there is recorded the main image before the image processing is performed thereon. For example, when image processing is first performed on a main image in a camera that acquired an image, a copy of the main image before the image processing is created and is recorded in the additional information section as a pre-edition image (pre-edition data) that is insusceptible to image processing.

That is, the image file treated in the present embodiment is constituted by a main image, which is post-edition data on which various types of image processing are performed, i.e., updated image, and an additional information unit that includes edition history data, a pre-edition image, and other additional information. As mentioned above, in the present embodiment, correlation is performed by recording the pre-edition image, the edition history data, and the main image in the image file.

The control device 103 includes a CPU, a memory and other peripheral circuits and is functionally provided with an image processing unit 103a and an image file outputting unit 103b. The memory that constitutes the control device 103 includes SDRAM and flash memories. The SDRAM is a volatile memory, which is used as a working memory of the CPU for expanding the programs upon execution thereof or as a buffer memory for temporarily storing data therein. The flash memory is a nonvolatile memory, which records various parameters to be read in into the CPU when programs are executed.

In the data file outputting device 100 according to the present embodiment, an instruction can be given to a plurality of image files recorded in the HDD 104 to output pre-edition data contained in each image file, a history image obtained by performing image processing on the pre-edition image with the edition history data, and the main image in separate files, respectively. For example, the user can select a predetermined folder in which image files are recorded and instruct to all the images recorded in the folder to execute file output processing in batch.

The image processing unit 103a, when batch output of the above-mentioned files is instructed by the user, reads in image files recorded in the selected folder on the SDRAM to acquire the main image, the pre-edition image, and the edition history data from the image file. Then, the image processing unit 103a reads in image processing parameters at each point in time in the past from the edition history data and performs image processing on the pre-edition image using them, respectively. This enables one to obtain history images that are results of editions performed in the course of starting from the pre-edition image until the main file is obtained.

The image file outputting unit 103b outputs image files such that the pre-edition image, the history image, and the main file are in separate files. As a result, an image file of the pre-edition image, an image file of the history image, and an image file of the main image are created from an original image file. Note that when the edition history data in the original image file contain edition histories at a plurality of points in time, a plurality of history image files are created from a single original image file.

The additional information section of an image file newly created by the image file outputting unit 103b does not contain the edition history data contained in the original image file. This enables one to distinguish whether the image file is an original image file or an image file created by the above-mentioned processing depending on whether or not there are edition history data in the additional information section.

The image file outputting unit 103b records the created image file in the same folder as that in which the original file in the HDD 104 is recorded. In this case, the image file outputting unit 103b assigns, to a pre-edition image file, a history image file, and a main image file created from an original image file from the same original image file, those file names that enable one to distinguish that these image files are output from the same original file. In the present embodiment, the image file outputting unit 103b assigns to the image files those file names that contain the same character string. This enables the user to distinguish a group of image files created from the same original image file from other image files at a glance.

Note that since the main image is stored in the original image file, the user can view the original image file and the newly created main image file the same. Therefore, if the main image file is given a file name that is different from the file name of the original image file, the user could be confused. Accordingly, the image file outputting unit 103b is configured to update the original image file by a newly created main image file, so that the file name of the main image file will be the same as the file name of the original image file. Alternatively, the image file outputting unit 103b may be configured to delete the original image file and assign the same file name as that of the original image file to the main image file.

For example, if the original image file has a file name of DSCN9414.JPG, the image file outputting unit 103b assigns a file name of DSCN9414.JPG to the main image file and a file name of DSCN9414._{—}1.JPG to the history image file. If there is a plurality of history image files, subsequently the attached numeral is increased such as DSCN9414_{—}3.JPG, DSCN9414_{—}4.JPG, and so on. Note that the attached numeral to indicate that the file concerned is a history image file is used so as to decrease for an older time of the image processing. This enables the user to grasp the order in which image processing was performed from the file names.

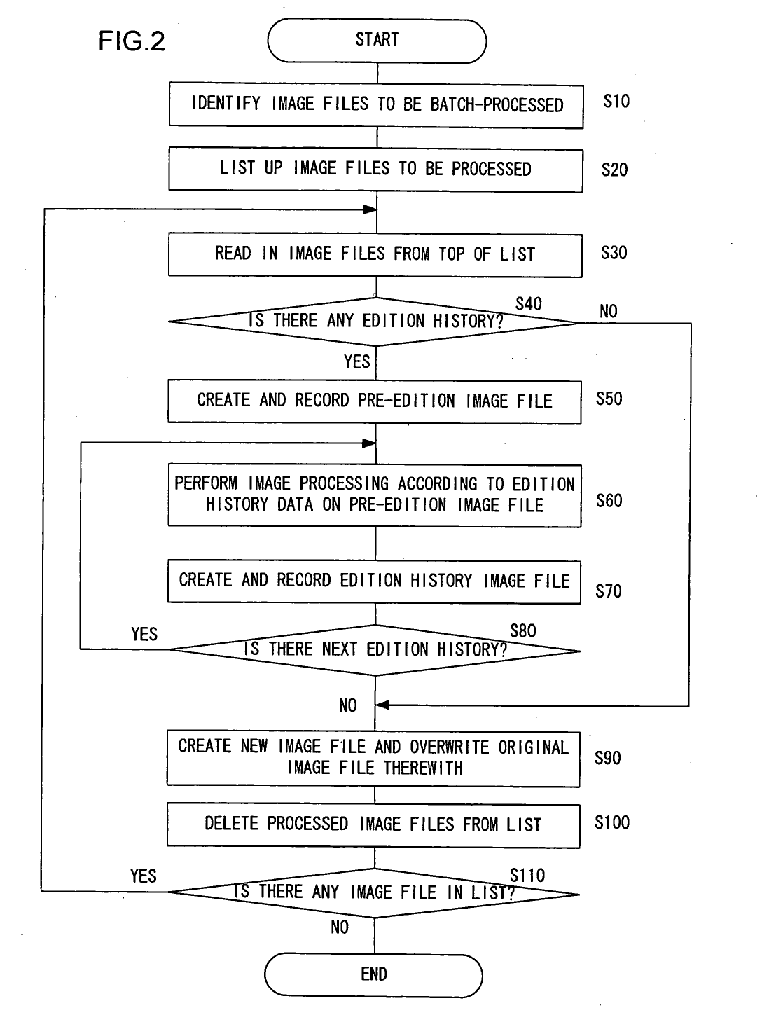

FIG. 2 is a flowchart illustrating processing to be executed by the data file outputting device 100 according to the present embodiment. The processing illustrated in FIG. 2 is executed by the control device 103b as a data outputting program that is started up when a specified folder is selected by the user and execution of the above-mentioned outputting of the image file in the selected folder as a target is instructed by the user.

In a step S10, the image processing unit 103a displays the image list displaying screen as shown in FIG. 2 on the monitor 105. In a step S20, the display control unit 103a determines whether or not any check box on the image list displaying screen has been clicked by the user. If the result of the determination in the step S20 is NO, the process is advanced to a step S80. If the result of the determination in the step S20 is YES, the process is advanced to a step S30.

In the step S30, the image processing unit 103a reads in an image file, i.e., original image file for the top of the list and the process is advanced to a step S40. In the step S40, the image processing unit 103a determines whether or not there has been recorded edition history data in the original image file contains an edition history, i.e., a set of image processing parameters at the image processing in the past. If the result of the determination in the step S40 is NO, the process is advanced to a step S100 to be detailed later on. On the contrary, if the result of the determination in the step S40 is YES, the process is advanced to a step S50.

In the step S50, the image file outputting unit 103b outputs the pre-edition image of the original image file to a file to create a pre-edition image file and record it in the same folder as that of the original image file. On this occasion, the image file outputting unit 103b assigns a file name to the pre-edition image file according to the above-mentioned rule of naming. Then, the process is advanced to a step S60.

In the step S60, the image processing unit 103a performs image processing on the pre-edition image of the original image file using the image processing parameters recorded as the edition history. On this occasion, the image processing unit 103a when a plurality of edition histories have been recorded as a result of a plurality of runs of image processing, performs the image processing on the pre-edition image according to the chronologically oldest edition history. Then, the process is advanced to a step S70.

In the step S70, the image file outputting unit 103b outputs the image obtained as a result of the image processing to create a file and records it in the same file as the original image file. On this occasion, the image file outputting unit 103b assigns a file name to the history image file according to the above-mentioned rule of naming. Then, the process is advanced to a step S80.

In the step S80, the image processing unit 103a determines whether or not there is an edition history at the next point in time in the edition history data. If the result of the determination in the step S80 is YES, the process is returned back to the step S60 and the image processing unit 103a performs image processing on the pre-edition image of the original image file according to the edition history at the next point in time. On the contrary, if the result of the determination in the step S80 is NO, the process is advanced to a step S90.

In the step S90, the image file outputting unit 103b outputs the main image of the original file to a file to create a main image file and overwrites the original image file therewith. Then, the process is advanced to a step S100, in which the image processing unit 103a deletes from the list processing completed image files on which the each processing in the steps S30 to S90 has been completed, and the process is advanced to a step S110. In the step S110, the image processing unit 103a determines whether or not there is an image file in the list. If the result of the determination in the step S110 is YES, the process is returned back to repeat the processing. On the contrary, if the result of the determination in the step S110 is NO, the processing is ended.

According to the present embodiment as detailed above, the following advantages can be obtained.

(1) The image processing unit 103a is configured to read in an image file having recorded therein a pre-edition image, edition history data, and a main image from the HDD 104 and applies the content of the image processing at each point in time contained in the edition history data to the pre-edition data to create a history image at each point in time. The image file outputting unit 103b is configured to output the pre-edition image, history image, and main image as different data files in batch. This makes it possible to readily output history images created in the course of image processing in the past.

(2) The image file outputting unit 103b is configured to assign file names to the pre-edition image, history image, and main image, respectively, such that each file name contains the same character string. This enables the user to distinguish at a glance a group of image files created from the same original image file.

(3) The control device is configured to correlate the pre-edition image, edition history data, and main image to each other by recording them in an image file. This makes it possible to easily correlate data to each other by using the image file format conventionally used.

—Modifications—The data file outputting device according to the above-mentioned embodiment can be modified as follows.

(1) In the above-mentioned embodiment, explanation has been made on the example in which the pre-edition image, edition history data, and main image are recorded in an image file to correlate them to each other. However, the correlation may be performed by another method. For example, the pre-edition image, edition history data, and main image may be registered in a database to correlate them to each other. This makes it possible to perform correlation of the data even when data other than the main images can not be recorded, such as the case where image files do not have additional information sections.

(2) In the above-mentioned embodiment, explanation has been made on the example in which the image files recorded in the folder selected by the user are made targets, which then are output in batch. However, all the image files recorded in the HDD 104 may be made as targets to be output in batch. Alternatively, the user may divide a plurality of image files into groups by using a database in advance and perform batch processing on image files that belong to a specified group.

(3) In the above-mentioned embodiment, explanation has been made on the example in which a pre-edition image, an edition history data, and a main image are created based on the pre-edition image, edition history data, and main image recorded in the image file. However, the target of the processing is not limited to images but may be other data of which edition can be performed. For example, it would also be acceptable to record a pre-edition document data, edition history data, and updated document data in a document file and create a pre-edition document file, a history document file reflecting the result of edition at each time in point, and an updated document file is created according to an instruction by the user.

(4) In the above-mentioned embodiment, explanation has been made on the example in which the image file outputting unit 103b assigns file names to the original image file, history image file, and main image file, respectively, such that the file names contain the same character string. However, it would also be acceptable to configure the control device such that when an instruction to record an image processing history is given by the user, an input of a name of the history is accepted and an image file containing the input history name is added to the history image file. This enables the user to grasp what edition has been performed on the created history file.

(5) In the above-mentioned embodiment, explanation has been made on the example in which a personal computer is used as the data file outputting device 100. However, other information equipment, for example, a server device may be used.

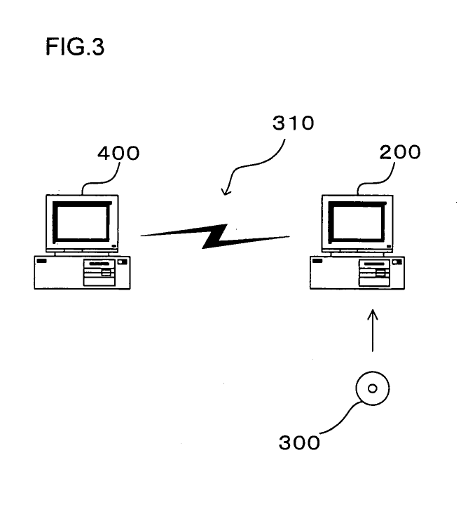

(6) The above-mentioned program relating to control can be provided through a recording medium such as CD=ROM or data communication such as the Internet. FIG. 3 is a diagram how the program is provided. A computer 200 is provided with a program through a CD-ROM 300. The computer 200 has a function of connecting with a communication line 310. A computer 400 is a server computer that provides the program and stores the program on a recording medium such as a hard disk drive. The communication line 310 includes, for example, communication lines such as the Internet, personal computer communication or dedicated communication lines. The computer 400 reads out a program through the communication line 310 using a hard disk drive and transmits the program as data signals to the computer 200. That is, the program is carried on a carrier wave to transmit through the communication line 310. In this manner, the program can be supplied as a computer readable computer program product in various forms such as a recording medium or carrier wave.

The above described embodiments are examples and various modifications can be made without departing from the scope of the present invention.

What is claimed is:

1. A computer-readable computer program product that contains a data file outputting program that is executed by a computer, the data file outputting program comprising:
a read-in instruction for reading in a plurality of data groups from a storage medium, the storage medium having recorded therein in correlation to each other a plurality of post-edition data as a result of edition by a user, a plurality of pre-edition data, which are originals of the post-edition data, and a plurality of edition history data in which contents of editions applied to the pre-edition data have been recorded at each point in time of edition in the course of creating the post-edition data, and each of the plurality of data groups including the post-edition data, the pre-edition data, and the edition history data in correlation to each other, one group after another;
a data creation instruction for applying, for each of the plurality of data groups read in by the read-in instruction, the content of edition at each point in time of edition to the pre-edition data based on the edition history data to create edition process data at each point in time; and
a file output instruction for outputting in batch the plurality of post-edition data, the plurality of pre-edition data, and the plurality of edition process data created by the data creation instruction as different data files, respectively.

2. A computer-readable computer program product according to claim 1, wherein:
in the file outputting instruction, file names each containing the same character string to a data file of the post-edition data, a data file of the pre-edition data, and a data file of the edition process data, respectively, are assigned to the post-edition data, the pre-edition data, and the edition process data being correlated to each other.

3. A computer-readable computer program product according to claim 1, wherein:
the post-edition data, the pre-edition data, and the edition process data are stored in a database to be correlated to each other.

4. A computer-readable computer program product according to claim 1, wherein:
the post-edition data, the pre-edition data, and the edition process data are stored in a data file to be correlated to each other.

5. A computer-readable computer program product according to claim 1, wherein
the pre-edition data and the post-edition data are image data, respectively, and the edition history data are data having recorded therein parameters representing a content of image processing performed on the pre-edition data.

6. A data file outputting device comprising a program executing unit-that executes a data file outputting program that is contained in a computer-readable computer program product according to claim 1.
